(19) United States
(12) Patent Application Publication
(10) Pub. No.: US 2006/0076517 A1
(43) Pub. Date: Apr. 13, 2006

(54) Optical curing apparatus

(76) Inventor: Shu-Lung Wang, Taipei Hsien (TW)

Correspondence Address: BIRCH STEWART KOLASCH & BIRCH, PO BOX 747, FALLS CHURCH, VA, 22040-0747, US

(21) Appl. No.: 10/960,080

(22) Filed: Oct. 8, 2004

(51) Int. Cl. A61C 13/15

(52) U.S. Cl. 250/504 R; 250/504 H; 250/492.1

(57) ABSTRACT

An optical curing apparatus to rapidly cure a dental resin filling in a decayed tooth includes a case, a radiation member located at the front end of the case having a light generating element built thereon and a seat coupling with a light channeling element. The seat is coupled with the case to connect one end of the light channeling element to the light generating element. The connection juncture of the light generating element and the light channeling element is covered by a shield which provides a shielding effect to fully direct the light generated by the light generating element in the light channeling element so that the light may be gathered and channeled to the front end of the light channeling element to rapidly cure the dental resin filling in the decayed tooth. Thus light projection time may be reduced at a smaller power output to save electricity consumption and increase life span and reduce cost.

### FIELD OF THE INVENTION

The present invention relates to an optical curing apparatus and particularly to an optical curing apparatus for curing a dental resin filled in a decayed tooth.

### BACKGROUND OF THE INVENTION

In the conventional dental care or examination practice, when a patient is found having a serious teeth decay, the dentist might suggest the decayed tooth be extracted. When the decay is minor and does have serious harm to the tooth, the dentist often tries to treat and mend the decayed tooth with a filler. In the past, the filler is made of metal powder mixing with a mending liquid. Nowadays, due to advances of technology, the filler is generally made from a dental resin.

During the dentist treats a decayed tooth by dispensing the filling resin in a decayed tooth, an optical curing apparatus is used to generate light to project and cure the resin for cementing the resin in the decayed tooth.

The conventional mending method mentioned above still has problems. Refer to FIG. 1 for a conventional optical curing apparatus. It includes a case 10, a radiation member 11 located at the front end of the case 10, a light generating element 12 located on the radiation member 11, a cap 13 coupling the front end of the case 10 and a fiber tube 14 coupled on the cap 13 to be in contact with the light generating element 12. The light generating element 12 generates light which is channeled by the fiber tube 14 and projects to the filling resin (not shown in the drawing) for curing.

The conventional optical curing apparatus set forth has a housing space 130 formed in the cap 13 that results in not effective light projection. Only the light passing through the contact surface 15 between the fiber tube 14 and the light generating element 12 is useful. Hence it needs a longer curing time to solidify the resin. To expose the human body under the light of the optical curing apparatus is harmful to the patient. Moreover, the optical curing apparatus consumes more electric energy and has to increase output power. Life span of the optical curing apparatus is shorter. The cost is higher. All this shows that there is still room for improvement.

### SUMMARY OF THE INVENTION

The primary object of the invention is to solve the aforesaid problems. The invention provides an optical curing apparatus that can cure and cement the dental resin filled in a decay tooth at a shortest time period without loosening.

Another object of the invention is to provide an optical curing apparatus that can reduce electricity consumption to decrease power output and increase life span and save cost.

Yet another object of the invention is to provide an optical curing apparatus that is easy to assemble and disassemble.

The optical curing apparatus according to the invention includes:

a case;

a radiation member located at the front end of the case having a light generating element built thereon;

a seat coupling with a light channeling element and housing a coupling member to anchor the light channeling element, and coupling with the case to enable one end of the light channeling element to connect to the light generating element; and

a shield to cover the connection juncture of the light generating element and the light channeling element.

The shield provides a shielding effect between the light generating element and the light channeling element so that light generated by the light generating element can be fully directed into the light channeling element and the front end thereof to rapidly cure the dental resin filled in a decayed tooth. The coupling member in the seat anchors the light channeling element securely and makes assembly and disassembly of the light channeling element easier.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional optical curing apparatus.

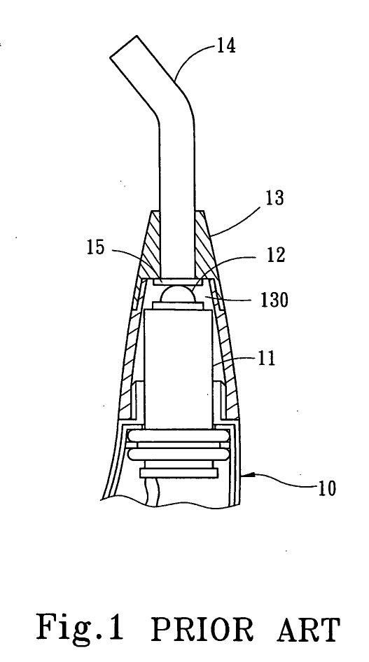

FIG. 2 is an exploded view of the invention.

FIG. 3 is a sectional view of the invention

FIG. 4 is a schematic view of light travelling according to the invention.

### DETAILED DESCRIPTION OF THE PREFERRED EMBODIMENTS

The optical curing apparatus of the invention mainly aims to use the generated light more efficiently to overcome the problems occurred to the conventional techniques. More details are elaborated as follow.

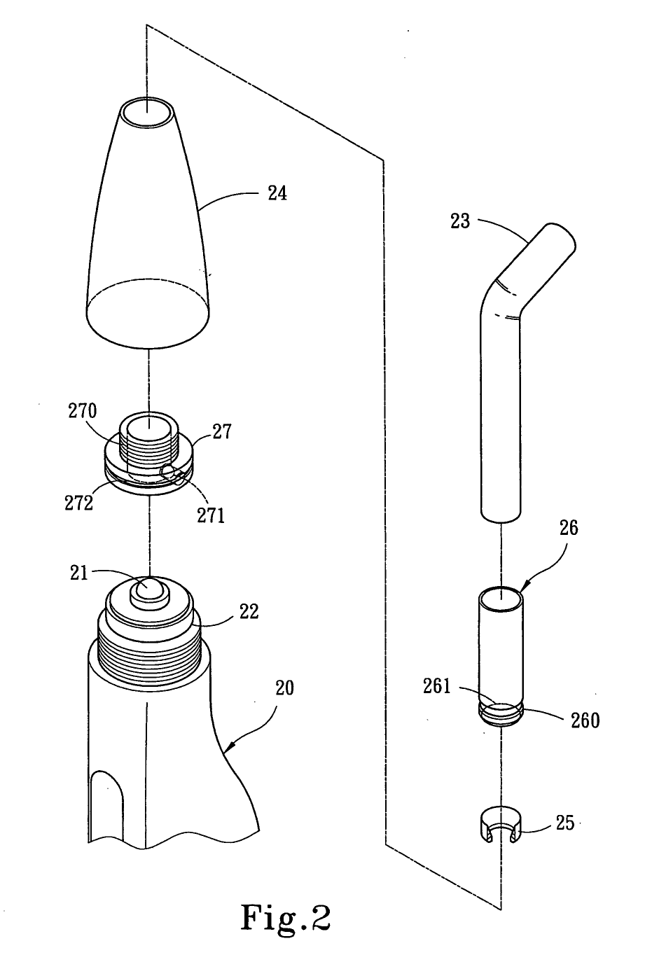

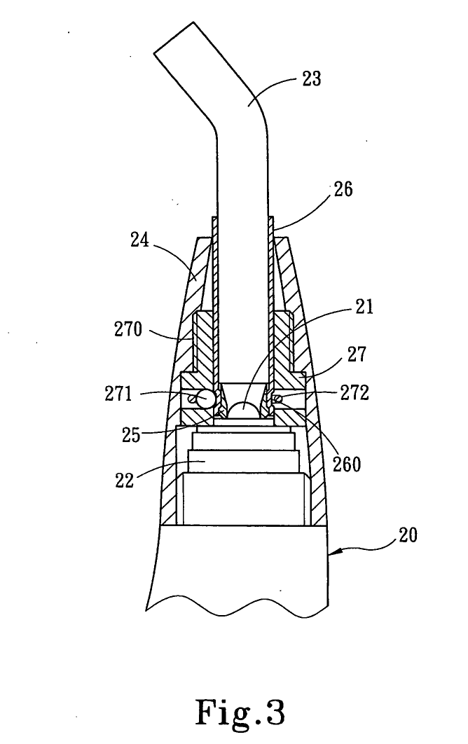

Referring to FIGS. 2 and 3, the optical curing apparatus according to the invention includes a case 20, a radiation member 22 located at the front end of the case 20 having a light generating element 21 (preferably a light emitting diode that generates blue light) built thereon, and a light channeling element 23 (may be coupled with a transparent protective element (not shown in the drawing) and formed with a tapered or straight front end, preferably a fiber tube) running through a seat 24 which is coupled on the front end of the case 20 (preferably by screwing). The light channeling element 23 has one end connecting to the light generating element 21. The connection juncture of the light generating element 21 and the light channeling element 23 is covered by a shield 25 (preferably made of metal). The shield 25 provides a shielding effect for the connection juncture of the light generating element 21 and the light channeling element 23. There is also a sleeve 26 to cover the connection ends of the light channeling element 23 and the light generating element 21. The sleeve 26 has a latch section 260 (preferably a groove) formed on the outer periphery of one end and a first coupling section 261 (preferably a housing bore) on the inner perimeter of the one end. The shield 25 is coupled on the first coupling section 261 (the sleeve 26 and the shield 25 may also be formed in an integrated manner). In addition, the seat 24 houses a coupling member 27 (preferably made of metal) to couple with the latch section 260 of the sleeve 26 to anchor the light channeling element 23 to the seat 24 (the coupling is accomplished through a steel ball 271 ramming on the coupling location of the coupling member 27 and the latch section of the light channeling element 23, and with an annular ring 272 strangling one end of the coupling member 27 over the steel ball 271 to confine the steel ball 271 in the latch section 260 while the latch section 260 is held in the coupling member 27). The coupling member 27 has a second coupling section 270 on one end to couple with the inner side of the seat 24 to fasten the coupling member 27 in the seat 24.

By means of the aforesaid structure, the shield 25 can cover the connection juncture of the light generating element 21 and the light channeling element 23 so that light generated by the light generating element 21 can be fully directed into the light channeling element 23 and travel to the front end of the light channeling element 23. Thereby the dental resin (not shown in the drawings) filling the decayed tooth may be cured rapidly at a shorter time. This can be accomplished at a smaller power output and save electricity consumption, and increase life span and reduce cost. The coupling member 27 is located in the seat 24 to anchor the light channeling element 23. The apparatus is easy to assemble and disassemble, and can provide multiple functions.

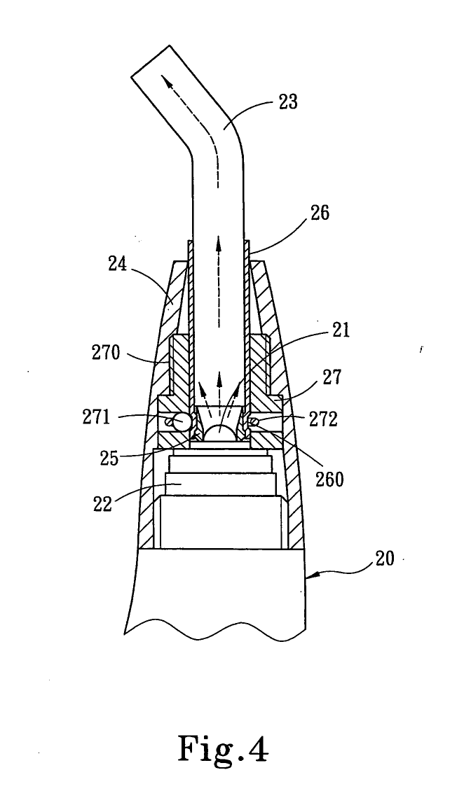

Refer to FIG. 4 for light traveling condition of the invention. As indicated by the arrows, light generated by the light generating element is directed into the light channeling element 23 to be channeled and output. Thus the light that might otherwise scatter away is trapped for productive use to enable curing of the dental resin (not shown in the drawing) filling in the decayed tooth to be accomplished rapidly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An optical curing apparatus, comprising a case, a radiation member located in a front end of the case having a light generating element built thereon, a light channeling element coupling with a seat which is fastened to the case and having one end connecting to the light generating element;
wherein the light generating element and the light channeling element are connected on a connection juncture which is covered by a shield to provide a shielding effect for the connection juncture.

2. The optical curing apparatus of claim 1, wherein the shield is made of metal.

3. The optical curing apparatus of claim 1 further having a sleeve coupled on the connection juncture of the light channeling element and the light generating element, the sleeve having a latch section on the outer periphery of one end abutting the coupling juncture and a first coupling section on an inner perimeter of the one end.

4. The optical curing apparatus of claim 3, wherein the first coupling section is a bore having a housing space.

5. The optical curing apparatus of claim 3, wherein the shield is fastened to the first coupling section.

6. The optical curing apparatus of claim 3, wherein the latch section is a groove

7. The optical curing apparatus of claim 3, wherein the sleeve and the shield are integrally formed.

8. The optical curing apparatus of claim 3, wherein the seat houses a coupling member which contains a steel ball to engage with the latch section of the sleeve to anchor the light channeling element on the seat.

9. The optical curing apparatus of claim 8, wherein the coupling member has a second coupling section on one end to couple with the seat to fasten the coupling member to the seat.

10. The optical curing apparatus of claim 8, wherein the coupling member is made of metal.

11. The optical curing apparatus of claim 1, wherein the light generating element is a blue light emitting diode.

12. The optical curing apparatus of claim 1, wherein the light channeling element is coupled with a transparent protective element and has a front end formed in a tapered or straight manner.

13. The optical curing apparatus of claim 1, wherein the light channeling element is a fiber tube.

14. The optical curing apparatus of claim 1, wherein the seat and the case have screw threads on the coupling locations for screwing with each other.
